(19) United States
(12) Patent Application Publication
(10) Pub. No.: US 2007/0034709 A1
(43) Pub. Date: Feb. 15, 2007

(54) Easy sprayer Assembly

(76) Inventor: Ester Lee Daniel JR., Clinton, LA (US)

Correspondence Address: Ester Lee Daniel Jr.;Bank Street, P.O. Box 630, Clinton, LA, 70722, US

(21) Appl. No.: 10/946,586

(22) Filed: Sep. 18, 2004

Related U.S. Application Data
(63) Continuation-in-part of application No. 10/282,961, filed on Oct. 28, 2002, now abandoned.

(51) Int. Cl. A01G 25/09; B05B 9/00; B05B 1/20

(52) U.S. Cl. 239/146; 239/149; 239/176

(57) ABSTRACT

The Easy Sprayer Assembly: is a portable sprayer assembly; comprising a platform/base, the platform/base providing support and stability for the said assembly. The platform/base providing a thin flat sturdy surface to support and facilitate the operation of an attached foot actuated manual pump. The said foot pump being the means of pressurizing the tank of a sprayer apparatus the tank of the said sprayer apparatus being also attached to the before said platform/base in close proximity to the before said foot pump. An operator actuates the foot actuated manual pump whilst the supporting base of the assembly is flat on the ground. Air inters the tank directly if the pump is internal to the tank. Air enters through an airline connected to an air inlet located generally on the upper section of the sprayer tank if the pump is external.

### BRIEF SUMMARY OF THE INVENTION

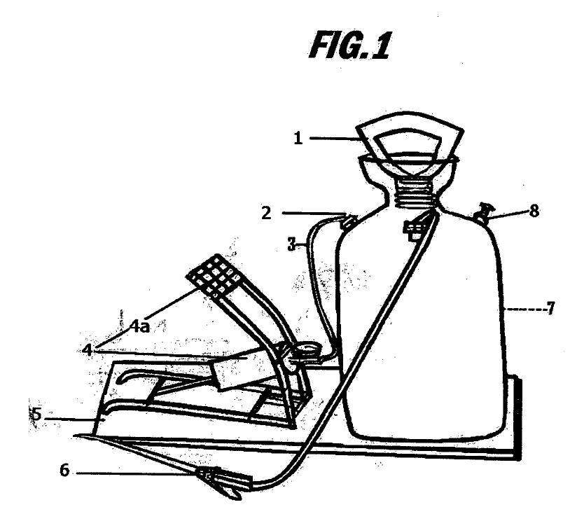

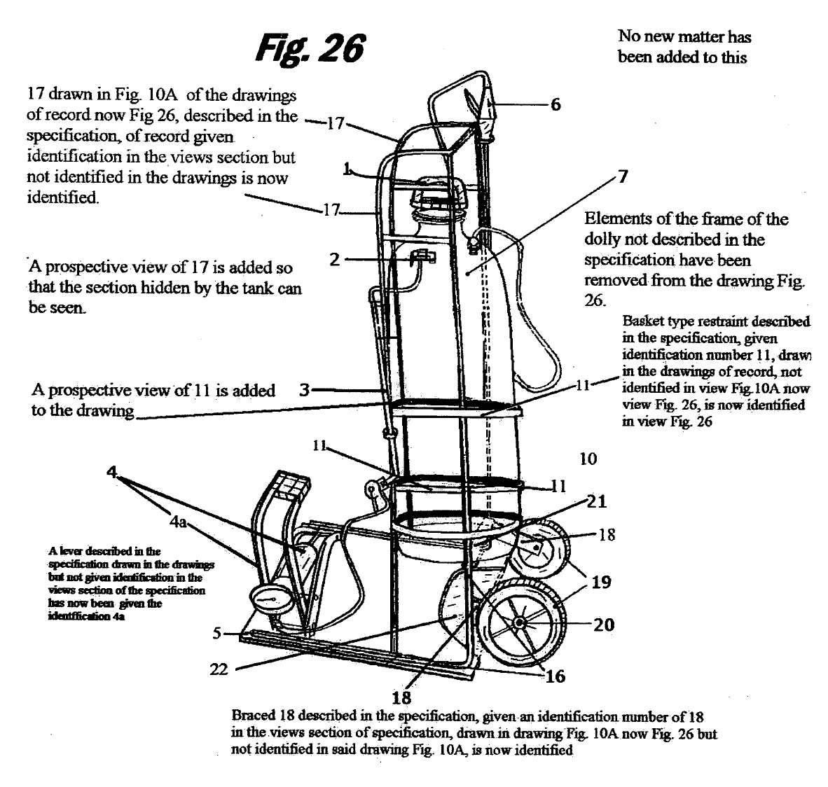

The Easy Sprayer is a manually pressurized sprayer assembly such as those used to spray herbicides, pesticides, industrial compounds and other liquids. The claimed invention a completed assembly of three main components of common occurrence, descriptively called an Easy Sprayer Assembly because, as the name implies the Easy Sprayer design concept is to make the physical operation of the common sprayer easier as relates to the manual operation of the pressurization means of a sprayer tank. Two basic features; in combination make the Easy Sprayer different from other manually pressurized sprayers. Firstly a foot actuated manual air pump 4, for pressurizing a sprayer tank connected to and supported by; the second component a base 5 a platform for, supporting the operation of the said foot actuated manual pump 4 in the pressurization of a sprayer tank 7. This concept in the design and operation of the sprayer can take many forms and many different types and designs of foot-operated pumps can be part of the construction of an easy sprayer. Models of the Easy Sprayer can be equipped with an attachable or a completely integrated dolly to aid in the transport of the assembly. The ease of operation of the Easy Sprayer format of a foot operated manual air pump and a sprayer tank connected to a common base will make it the most popular manually pressurized sprayer assembly to hit the market. The Easy Sprayer Base Assembly is the descriptive name given to all variants of the platform that is the claimed improvement in the art. The said platforms of a supporting base and means of actuating an air pump, by the use of a human foot repeatedly pushing down on then releasing the said means. The said variants ranging from a simple design of a flat board with foot actuated pump attached View FIG. 1 to complicated designs of dollies view FIG. 26. All said variants meeting the functional design description of a platform its supporting base when placed flat on the ground provides support for and/or enabling means of operation of a manual pressurization means, said pressurization means a manual pump actuated by the use of the human foot. Said pump used to pressurize the tank of a sprayer apparatus said means solidly connected to the before said platform to be in close proximity to the tank of the sprayer apparatus used in any of said variants. The Easy Sprayer Base assemblies that incorporate the use of dollies will be the most popular sprayer utilities.

The purpose of this inventor is not only to provide an assembly that is easy to pressurize but also an assembly that is easy to transport. The use of the dolly is therefore an important aspect of the design of the Easy Sprayer Assembly. The most efficient designs of dollies used as a means of transport of an easy sprayer, have the functional embodiment of the invention incorporated in the design of the dolly it self. For the base of the said dolly has also attached a foot actuated manual air pump. This in effect makes the dolly itself a version of an Easy Sprayer Base Assembly. Attaching the tank of a sprayer assembly to the before said dolly now creates a full version of an Easy Sprayer Assembly.

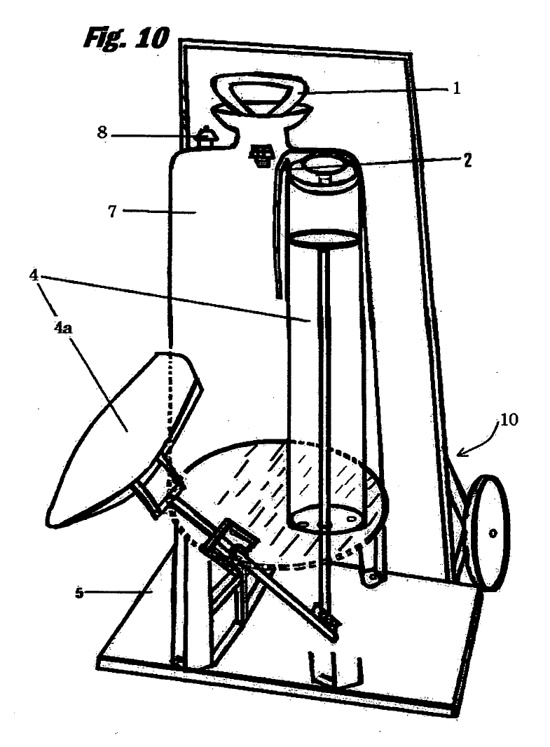

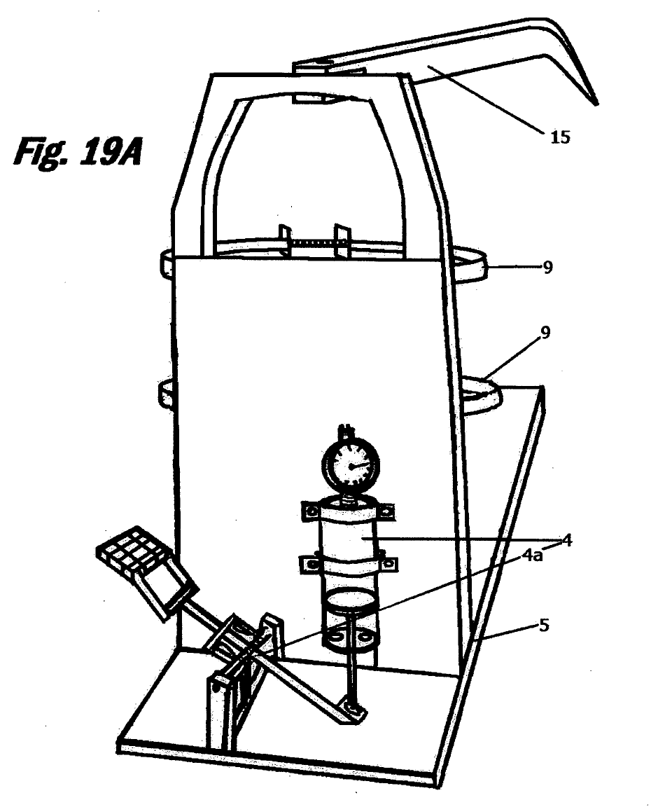

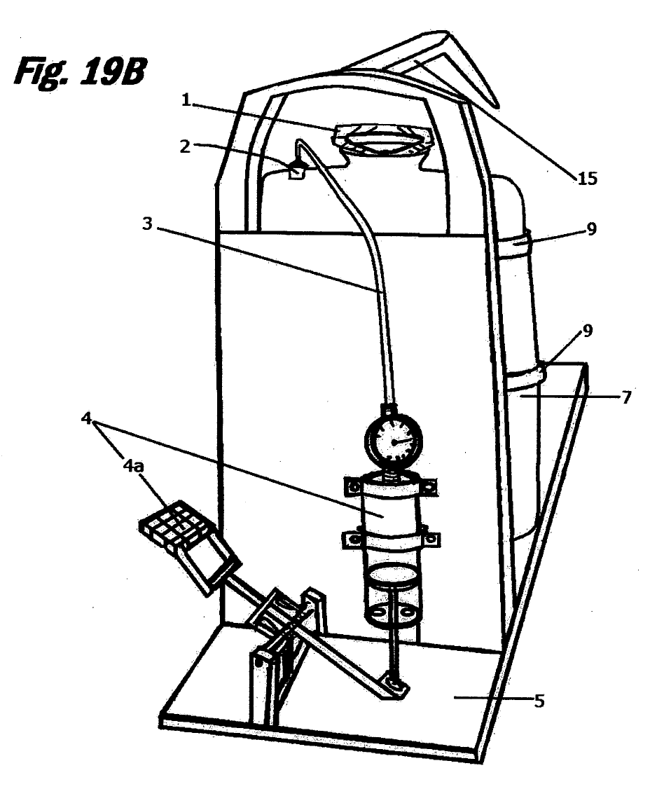

View FIG. 1 the first embodiment, of an Easy Sprayer Assembly was developed with portable sprayer assemblies equipped with tanks of a cylindrical design in mind, tanks designed to be carried by hand and to hold a liquid capacity of one two or three gallons. Other embodiments of a hand carried version of the invention; chiefly demonstrated in View FIG. 10 through View FIG. 19B illustrate the fact that anyone skilled in the art can take the sprayer assemblies of virtually any design in the art and transform that assembly into a version of an easy sprayer. The descriptions; of these embodiments are limited because they are included primarily as examples of the many possibilities in design and meant to illustrate some of the protections sought by this inventor for his invention. Some elements of the prior art can be found in each design for example View FIG. 19A through FIG. 19B illustrate the use of handles extending up from the base. Though the design of the handles in the embodiments in no way resembles that of the Kirch disclosure, and the base serves a purpose not disclosed or claimed by kirch that purpose being providing a means of supporting the operation of a foot actuated manual pump. The tray means of transport, described by Kirch, some 27 years ago is evident. See Kirch Paul W. U.S. Pat. No. 3,977,602 issued Aug. 31, 1976. VIEWS FIG. 10 through FIG. 17 illustrate some possibilities of arrangement and type, of manual pump that may be used in an Easy Sprayer Assembly. The foot pumps used in the preferred embodiment of the disclosure are of common occurrence; easily purchased in for example an auto-parts store. However there are many different kinds of pumps in the prior art that are not of common occurrence and many different arrangements. I claim as my invention an assembly comprising any of foot actuated manual pumps any hand actuated manual pumps modified to be actuated by use of an operator's foot as a means of operating the pressurization system of a sprayer assembly that sprayer assembly being in close proximity to the said foot pump and a supporting base. See Yamamoto, U.S. Pat. No. 6,155,498; see Jacobs U.S. Pat. No. 4,384,675 and Jacobs U.S. Pat. No. 4,397,420. Also sprayer tank designs normally provided with means other than hand actuated pumps to pressurize the said tank, may be part of an Easy Sprayer Assembly (See Luvisotto, Roy G U.S. Pat. No. 4,865,255).

### BRIEF DESCRIPTION OF THE SEVERAL VIEWS OF THE DRAWINGS

### Reference Characters

1 is a solid cap with handle to seal and carry an assembly used in the most basic design of the claimed invention.

2 is an air inlet generally to connect an external air supply to a sprayer tank.

3 is an airline, means of connecting the air supply of an external means of connecting the air supply of an external foot actuated air pump to a sprayer tank.

4 a manually operated pressurization means generally an air pump a common occurrence, said pressurization means in a design format in which said pressurization means is operated by use of the human foot. Manually operated pumps of any type used to pressurize a tank of a sprayer apparatus may be used in an Easy Sprayer Assembly, provided said pumps or foot actuated or modification/s made to make a said pump foot actuated.

4a a lever a common occurrence in the art of pressurizing devices. Said lever 4a a manual operating means, of a pressurization means 4 a said pressurization means and its manual operating means in a format in which the use of the human foot is intended as means of manually actuating said actuating means 4a to operate said pressurization means 4 to pressurize a tank of a sprayer apparatus.

5 is a base/platform on which a foot pump and a sprayer tank are connected in close communication.

6 is the sprayer hose and nozzle of a sprayer assembly.

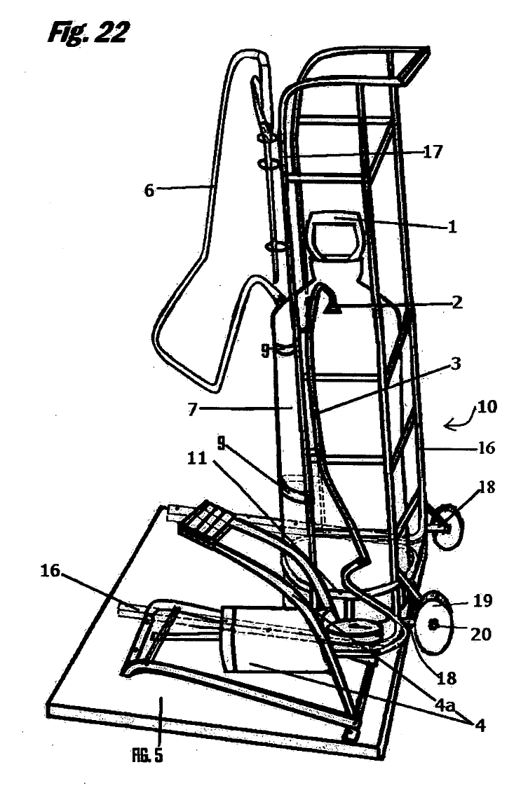

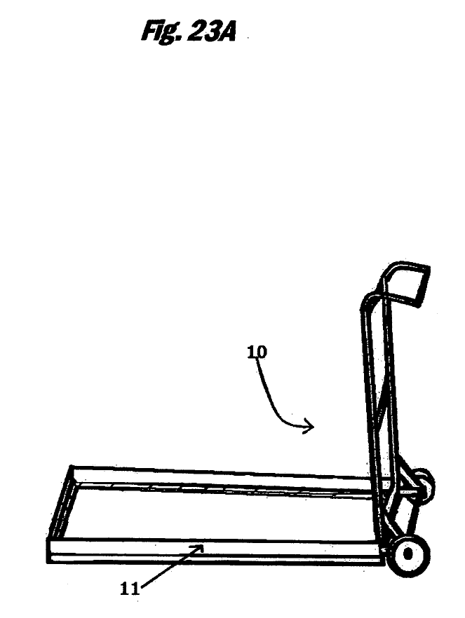

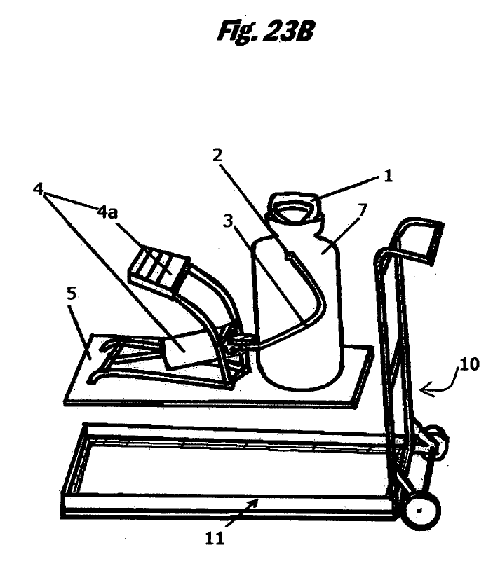

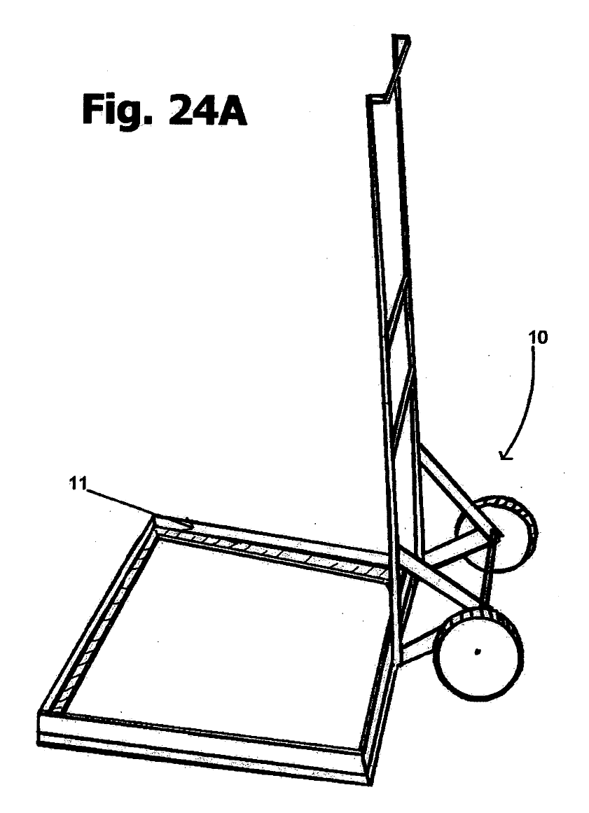

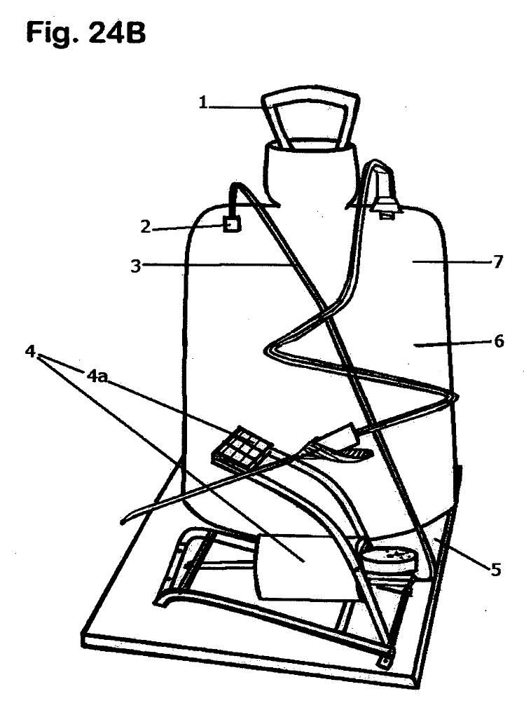

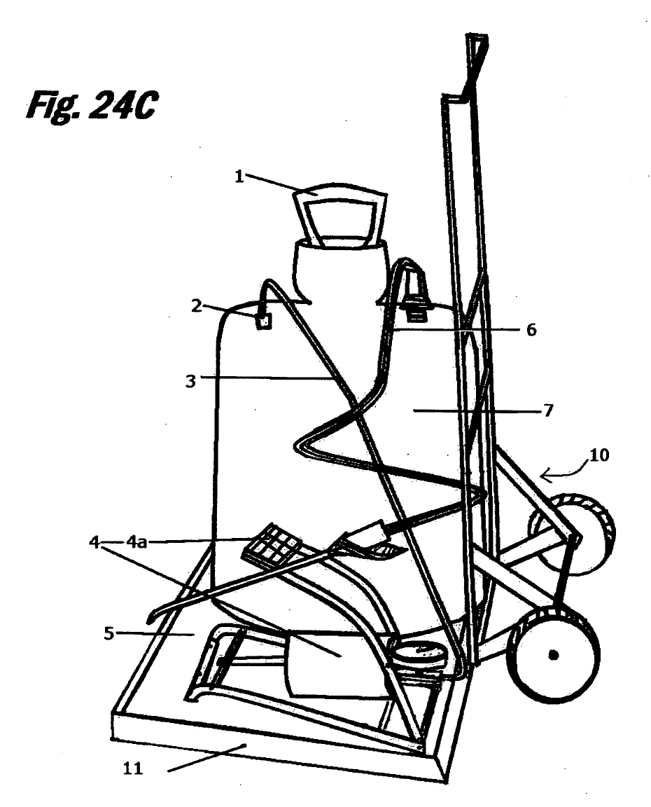

11 is a tray/basket section of a dolly used to secure the tank of a sprayer apparatus to a dolly on which the claimed invention is incorporated as in view FIG. 22 and view FIG. 26, or used to secure hand carried versions of the claimed invention as in view FIG. 23A and FIG. 23B and view FIG. 24A, FIG. 24B and FIG. 24C. The said hand carried versions of the claimed invention used in conjunction with or independently of the said dollies said dollies designed to secure Easy Sprayer Assemblies said assembly's of a corresponding design to that of said dollies. Please note the term basket type restraint is used to mean that the restraint is part of the structure that forms a basket or tray. In all cases in this disclosure, the term basket type restraint particularly means the outer railing of a basket or tray.

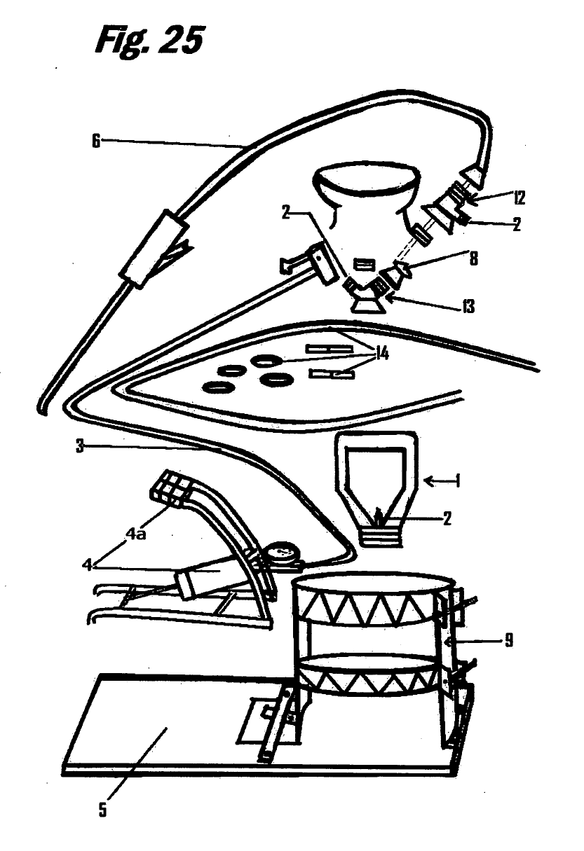

12 in FIG. 25 is an example of an adapter for an Easy Sprayer conversion kit, with an air inlet for the airline of a foot actuated manual air pump designed to be installed at the sprayer hose connections on the tanks of different models of garden sprayers.

13 in FIG. 25 is an example of an adapter for an Easy Sprayer conversion kit with an air inlet 2 for the airline of a foot actuated manual air pump; designed to be installed at locations were accessories such as pressure release valves 8, etc. would go on the tanks of different brands and models of sprayers assemblies.

14 in FIG. 25 is an illustration of a section of hose with hard ware (hose clamps and inserts) to extend the length of the sprayer hose and nozzle assembly 6 of different models of garden sprayers.

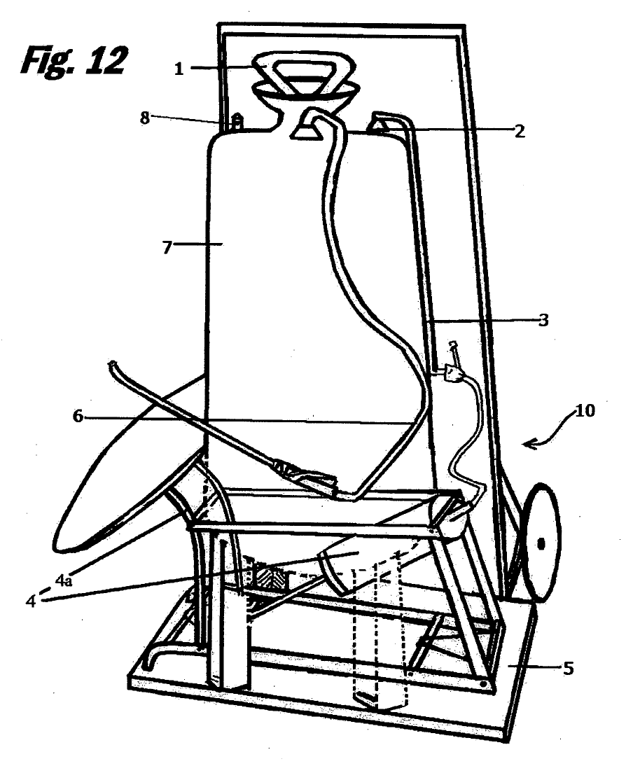

1 in FIG. 25 equipped with an air inlet. 2 for an airline 3 of a foot-operated air pump 4, is an example of a top designed as a replacement for some tops with integrated hand pumps of different brands and models of garden sprayers. Also in view, FIG. 25 are examples of character FIGS. 12, 13 and 14.

15 is a handle extending up from the base support of a base assembly.

The Reference Characters now presented represent features dedicated to best designs in mode of transportation as relates to dollies. FIG. 26 Illustrates the best basic features to achieve the most portable designs of dolly used as part of an Easy Sprayer Assembly.

A brace 21 that extends between the rails of the upper main frame member above the rear edge of the base support of FIG. 26, supports a tank when the said tank is placed in a basket type restraint 11 said restraint formed by additional bracing that extend around upper frame members 16 and 17 said frame members 16 and 17 forming the main body for said basket and the said brace 21 forming the bottom of said basket. members 16 and 17 said frame members 16 and 17 forming the main body for said basket and the said brace 21 forming the bottom of said basket.

22 A section of the base generally rectangular is removed from inner rear of the base support creating additional ground clearance.

### VIEWS

FIG. 1 composed of Reference Characters 1 though 8 shows the completed assembly of an Easy Sprayer as originally conceived.

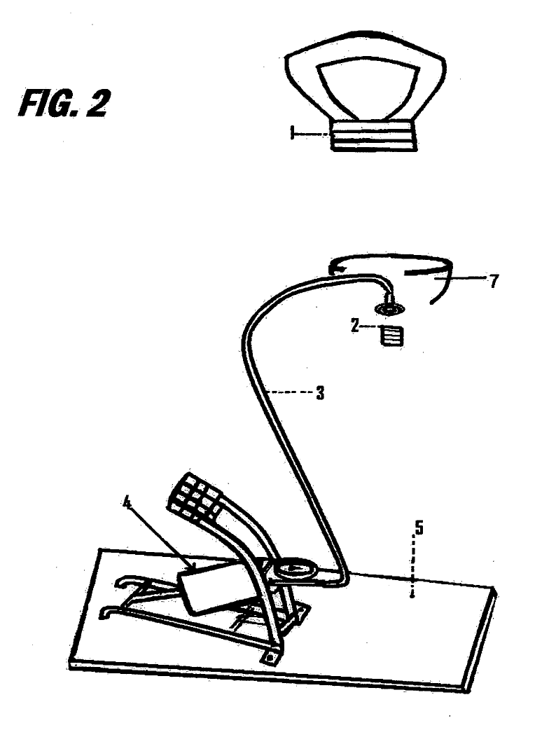

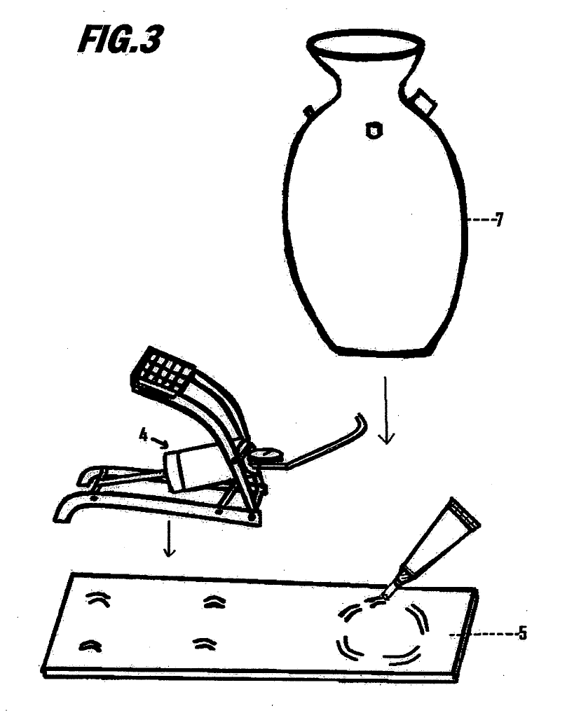

FIG. 2. This exploded view illustrates the basics of the claimed invention. It shows the two main components of the claimed operating format a base/operating platform 5 and. a foot actuated-manual pump 4 each of common occurrence, the two components when connected together as a unit form an example of the fundamental format of that claimed as an improvement in the art, an Easy Sprayer Base Assembly. The third component a sprayer tank creates a completed Easy Sprayer Assembly. In this exploded view only the upper section of a tank 7 is shown because this view is meant to point out the two prior said components of base 5 and foot actuated manual pump 4 that make an Easy Sprayer Assembly unique, An air in-let 2 is shown near this section. Said air in-let provided on a sprayer tank for an airline 3 of a foot-actuated air pump. A solid cap with handle 1 which takes the place of the integrated air pump and cap design of much of the prior art is shown. This cap is removed from a tank 7 then replaced to seal a said tank, then used to carry an assembly by way of a said tank a said tank being connected to the before said base 5 along with a before said foot actuated pump 4. This view shows a basic blueprint for the claimed format in which the manual means of pressurizing the tank of a sprayer apparatus, is foot actuated and secured to a platform said platform stationary when said pressurizing means is actuated.

FIG. 3 through FIG. 9, these exploded views show seven variant methods of connecting a foot actuated manual pump and a sprayer tank to a common base to assemble an Easy Sprayer of FIG. 1.

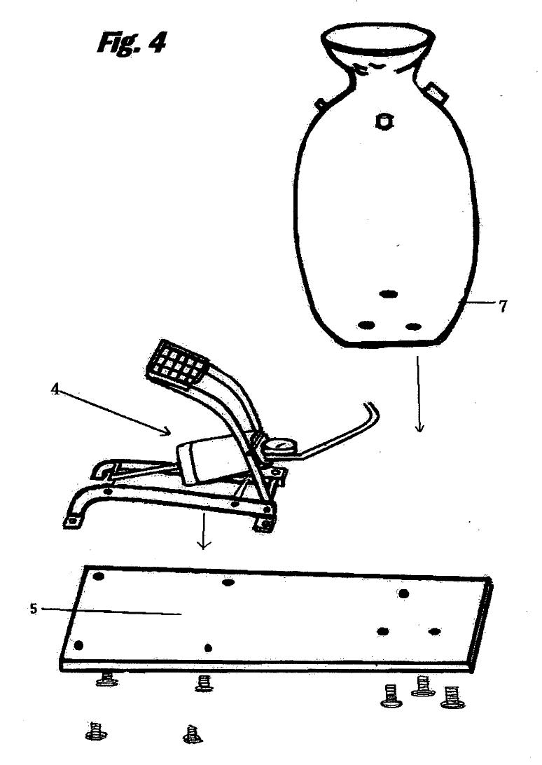

FIG. 4 shows the use of bolts to attach a foot pump and sprayer tank to a base.

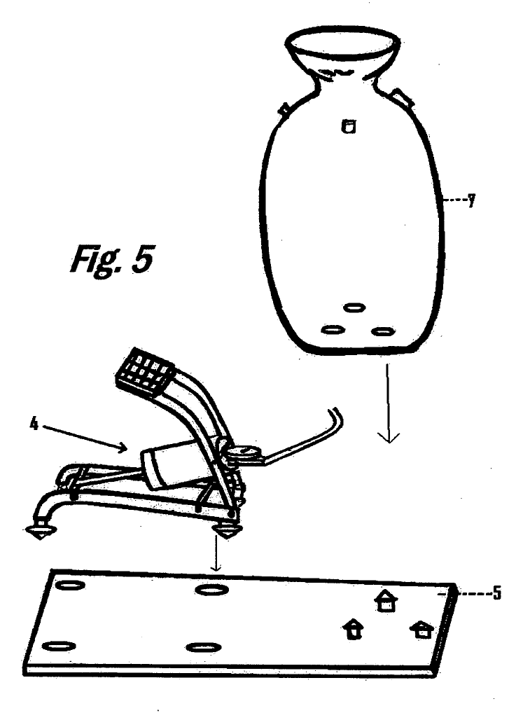

FIG. 5 shows the foot pump, sprayer tank and base designed to snap together.

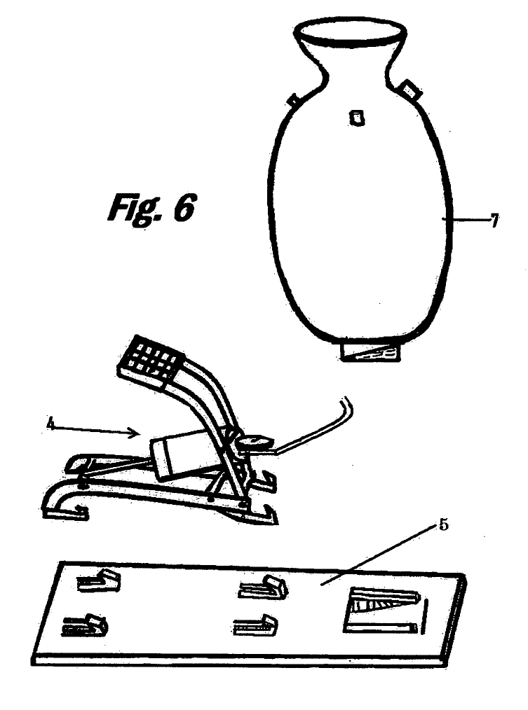

FIG. 6 shows a slide lock design for the attachment of the main component parts.

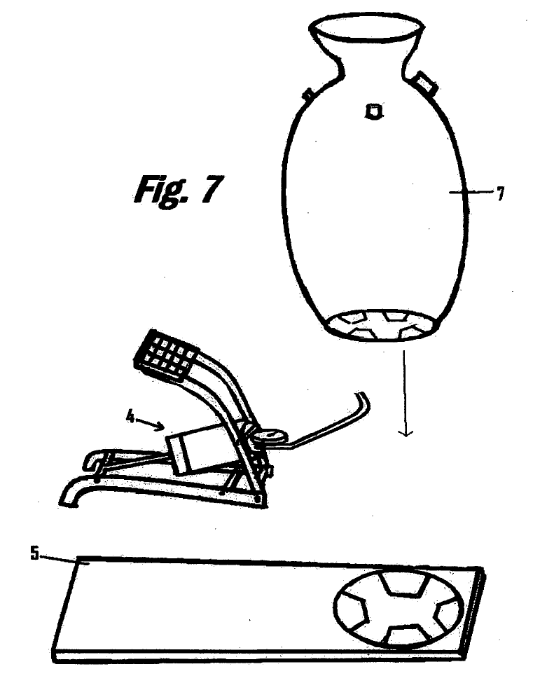

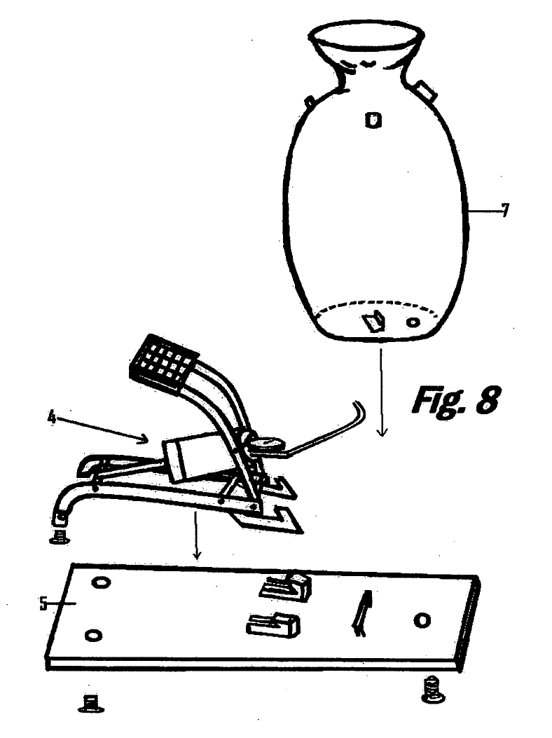

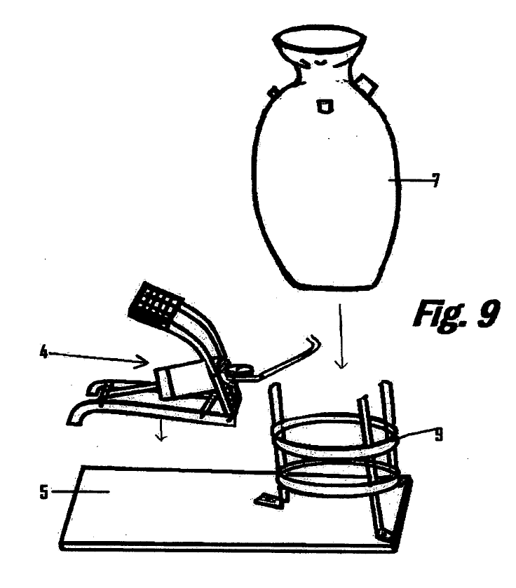

FIG. 7 shows a sprayer tank and a base designed to twist lock into position.

FIG. 8 shows a design in which the foot-pump and the sprayer tank first slide into position, and are then secured with bolts.

FIG. 9 shows an illustration of an adjustable restraint with which to hold a sprayer tank.

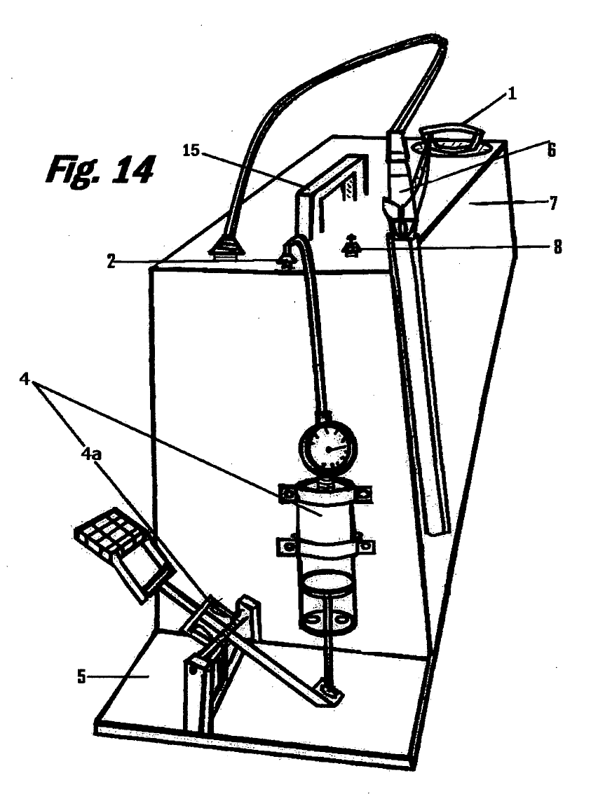

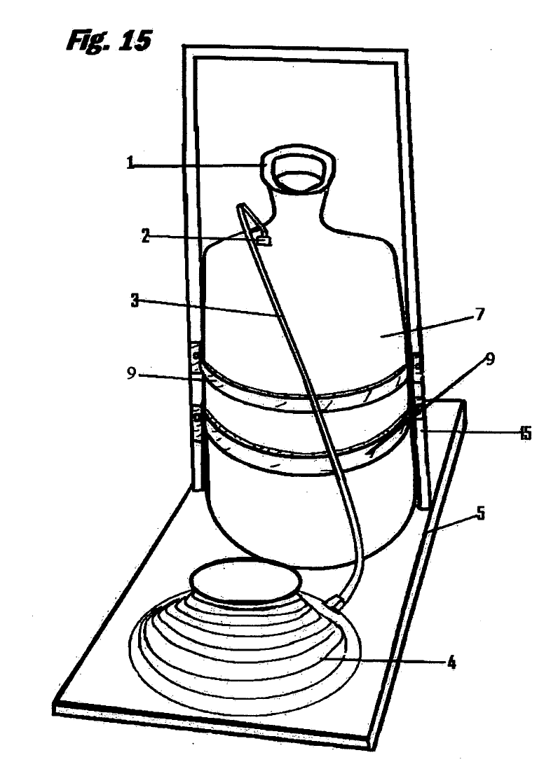

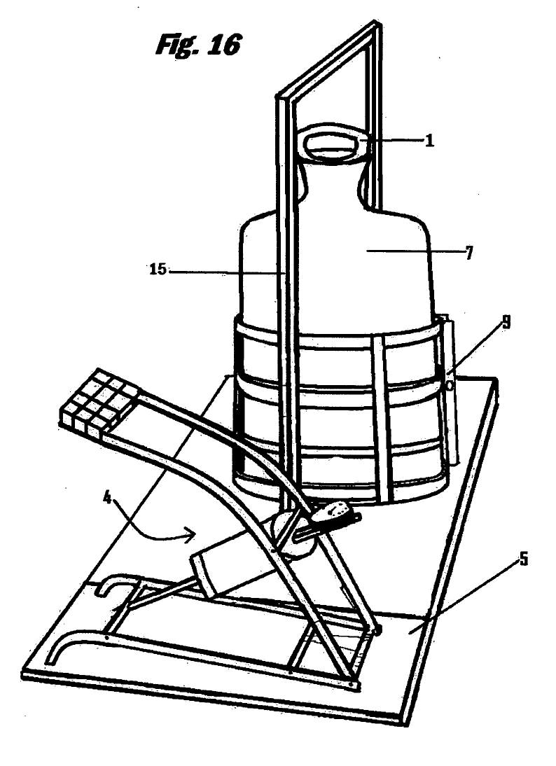

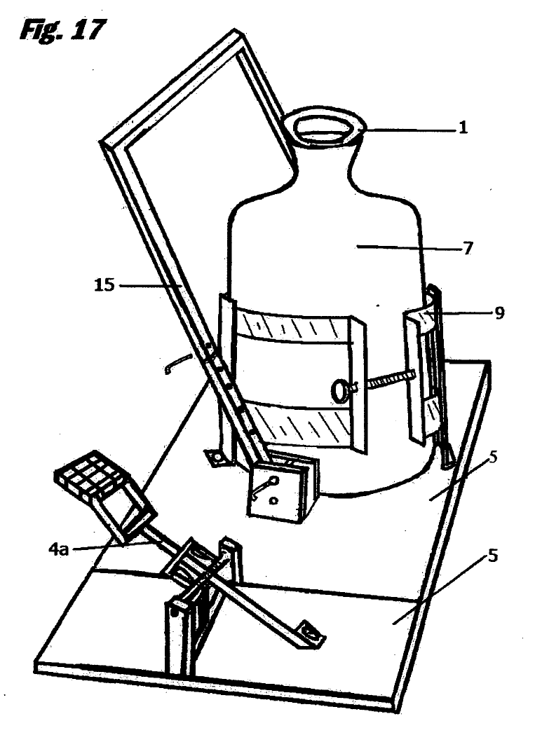

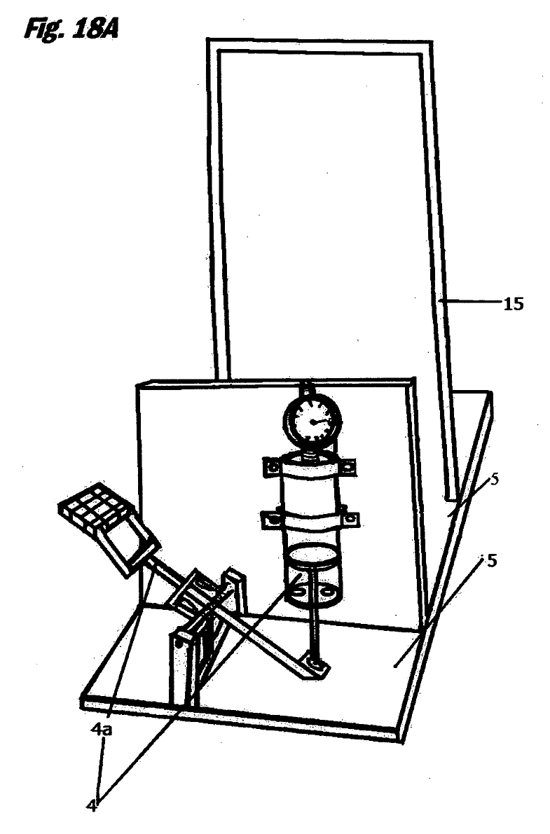

FIG. 10 through FIG. 19B were included in this document to illustrate a few of the many other possible embodiments of an Easy Sprayer Assembly, an Easy Sprayer base/platform with foot pump assembly, and the foot pumps used in the composition. Observe in views FIG. 10 through FIG. 19B, only views FIG. 12 and FIG. 14 show the eight character figures that are described as being parts of a completed Easy Sprayer Assembly as originally conceived view FIG. 1. A sprayer holes and nozzle assembly is not shown in the remaining views. Other components, common or necessary for the operation of a sprayer utility or not shown in some views. Components such as pressure release valves, air inlets or airlines. The said components are of common occurrence in the art. The before said drawings are meant to show the fundamental relationship between the three primary components of the claimed improvement in the art. A supporting platform/base support 5, a manually actuated air pump designed to be actuated by use of the human foot 4, said pump connected indirectly or directly to a tank 7 of a sprayer apparatus, the two said components of foot actuated pump and the tank of a sprayer apparatus, in common attachment to a before said platform.

FIG. 10 shows an example of a foot actuated manual air pump with its' compression cylinder built directly into a sprayer tank.

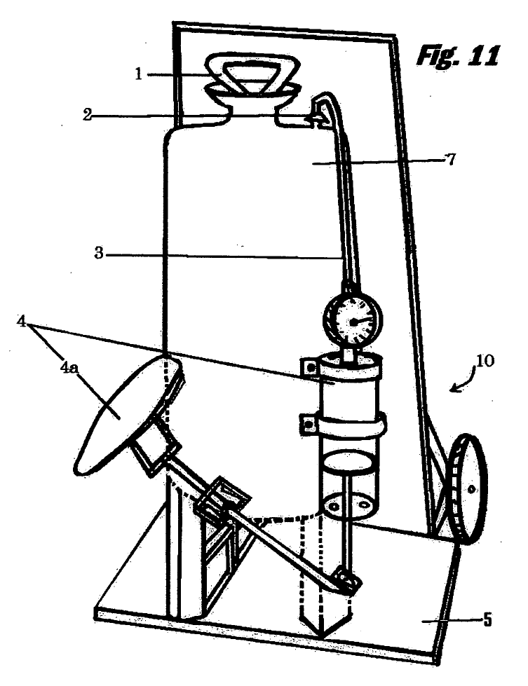

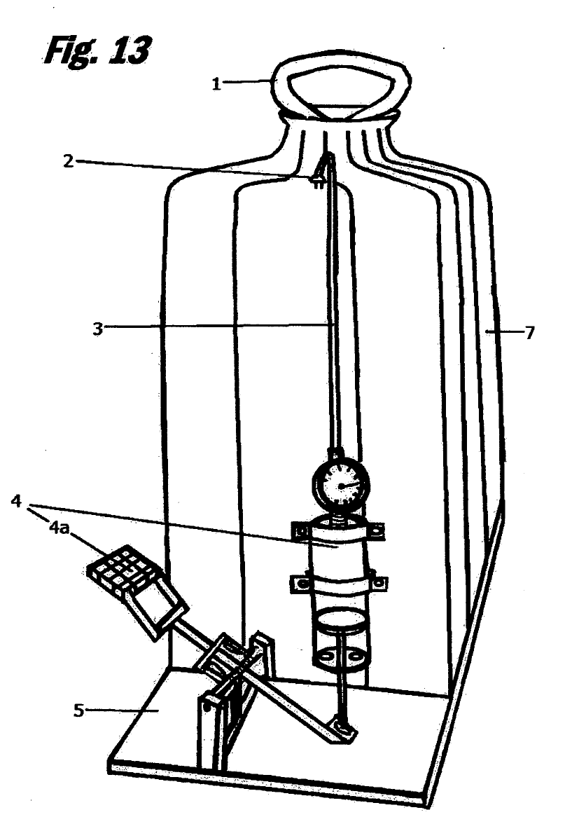

FIG. 11, FIG. 13 and FIG. 14 each show an example of a foot-operated pump with its compression cylinder attached to the exterior of a sprayer tank.

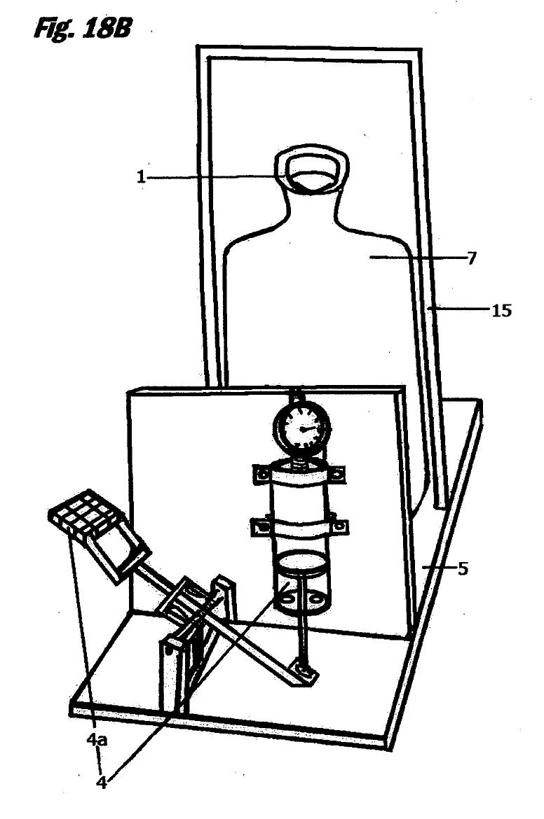

FIG. 15 shows a foot-operated manual pump assembled beneath a sprayer tank.

FIG. 15 shows an example of a diaphragm type foot-pump.

FIG. 16 shows the use of a foot pump commonly used to inflate things such as bicycle tires, inflatable toys, and the tires of small film utility vehicles and tools.

FIG. 17 shows a lever an operating means of common occurrence. Said lever designed to be actuated by use of the human foot stepping on then off said lever actuating a pressurization means said pressurization means connected to said lever being generally a manually actuated air pump of common occurrence.

FIG. 15 through FIG. 19B illustrate embodiments of the Easy Sprayer with a handle 15 for carrying an assembly connected to and extended up from a base.

FIG. 15, FIG. 16, FIG. 17, FIG. 18A and FIG. 18B each illustrate designs of the claimed invention in which a sprayer tank is placed and held between a handle 15 that extends up from the base.

FIG. 18A illustrates an example of the claimed improvement in the art, a design of Easy Sprayer Base Assembly. A portable platform on which a foot actuated manual pump is generally solidly attached.

FIG. 18B a third component the tank of a sprayer apparatus is shown installed onto the before said Easy Sprayer Base Assembly of view FIG. 18A completing a basic format of an Easy Sprayer Assembly.

FIG. 17 illustrates a handle 15 as described in view FIGS. 15 through 18B said handle in this view adjustable in height and position.

FIG. 19A and FIG. 19B show a design of an Easy Sprayer Base Assembly in which a handle 15 is part of an upward extension from a base the said extension located in front of the sprayer tank said handle 15 can shift from its center carrying position FIG. 19A to one side to allow access so that a sprayer tank 7 can be placed on the platform as shown in view FIG. 19B.

FIGS. (20A and 20B) and FIGS. (21A and 21B) show two examples of an Easy Sprayer Base designed as a dolly that the remaining components of foot-pump and sprayer tank are later attached.

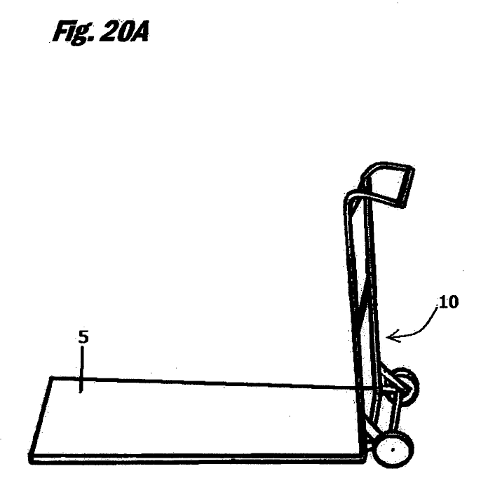

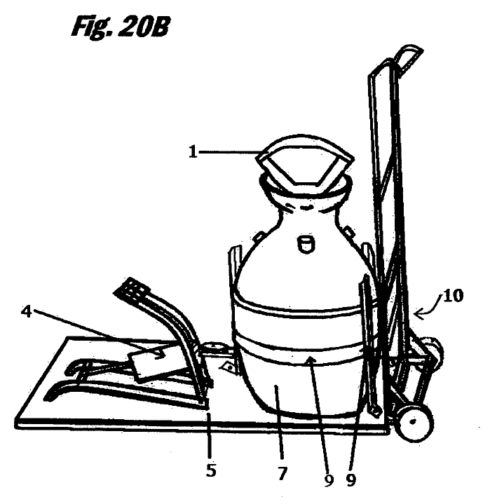

FIG. 20A shows an Easy Sprayer Base design, solidly made as the lifting platform of a dolly 10.

FIG. 20B shows a foot operated air pump 5 bolted to this base designed as a dolly in FIG. 20A; along with a sprayer tank 7 attached using an adjustable restraint 9 forming an example of the claimed invention designed as a dolly.

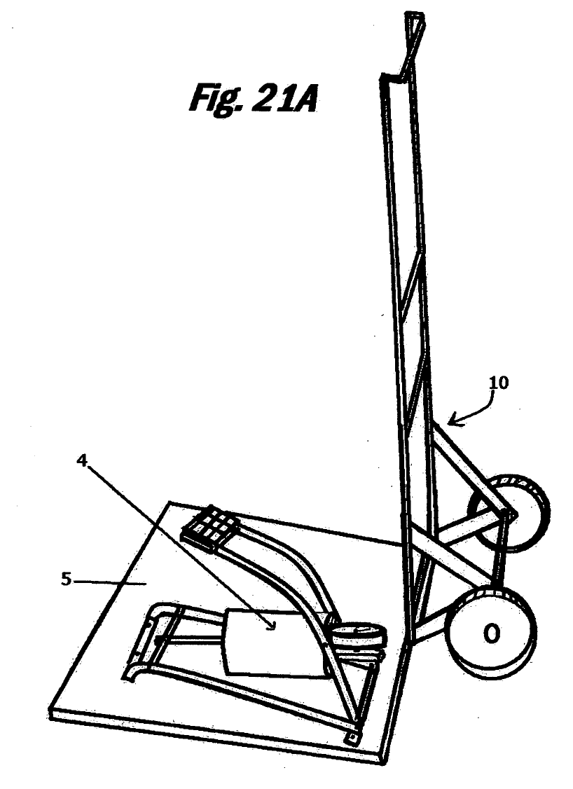

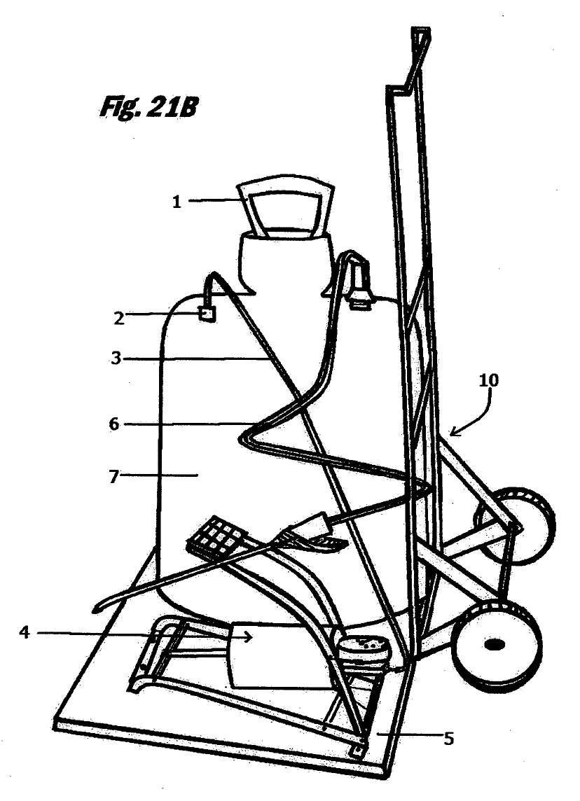

FIG. 21A shows another example of an Easy Sprayer Base 5 as the platform part of a dolly 10; with—a foot actuated manual air pump 4 included.

FIG. 21B shows a base and dolly assembly as shown in FIG. 20A with a sprayer assembly added forming a completed Easy Sprayer Assembly with dolly. As no visible restraint for the tank of the assembly is apparent the method of attachment of the tank to the base, can be that of any of the methods described in FIG. 3 through FIG. 8.

FIG. 22 shows a large capacity sprayer tank connected to an Easy Sprayer Base and dolly assembly.

FIGS. (23A and 23B,) and FIGS. (23A, 23B and 23C) show the Easy Sprayer as an assembly of a dolly and Easy Sprayer base, in which the dolly is designed to transport the assembly; that can if needed be easily be removed from the dolly, to be used independently of the dolly. Then easily reinstalled onto the dolly by placing the assembly back into the dolly's (in the case of these examples) tray.

FIG. 23A shows a dolly designed with a tray shaped to hold the base of an Easy Sprayer Assembly.

FIG. 23B shows this before said dolly of view FIG. 23A and an Easy Sprayer Assembly about to be placed inside the tray of the said dolly.

FIG. 24A shows another example of a dolly designed with a tray to hold the base of an Easy Sprayer Assembly.

FIG. 24B shows an Easy Sprayer Assembly designed with a base that allows easy placement of an assembly into and easy removal of an assembly from the dolly shown in FIG. 24A.

FIG. 24C shows the Easy Sprayer Assembly shown in FIG. 24B placed in the tray of the dolly shown in FIG. 24A.

FIG. 25 is an illustration of the subject matter of the Easy Sprayer designed as components of a conversion kit used to transform different brands and models of garden sprayers into versions of an easy sprayer

FIG. 26 illustrates an assembly that incorporates design features of many of the preceding views: the basic design of FIG. 22, but the foot pump positioned to its side and in front of the tank as in View FIG. 16, an elevated tank as in FIG. 12, secured between the railings as in 15 through 18B where the handles extending from the base serve a similar purpose as the rails of the dolly in view FIG. 26. That claimed as the invention is universally applicable too much of the prior art of portable sprayer apparatuses. Therefore, except for the original design FIG. 1, few details for most of the various views presented in the original disclosure beyond descriptions of the arrangement of and type of the three main components are specified. FIG. 26 illustrates an expanded description of an improved FIG. 22 said improvements relate to the transport of the assembly. That claimed as the invention works the same no matter how efficient the mode of transport, no matter how efficient the design of sprayer apparatus used in an assembly, no matter the length or shape of the supporting base of a portable assembly

The Easy Sprayer is an assembly of components, common in the art of sprayer assemblies. A sprayer assembly and a foot actuated manual air pump brought together so that one the foot-pump would make the other the, sprayer assembly easier to use. The core of what makes the Easy Sprayer different from the prior art is the use of a foot actuated manual air pump 4 used to pressurize the tank 7 in conjunction with and solidly attached to a platform/base 5 on which the tank 7 of a sprayer assembly is also attached and supported. This platform is not human, not animal but made of an inanimate material designed to support and convey the foot actuated manual air pump and sprayer assembly attached to it as a unit. Many models of the prior art, sprayers designed with built in hand operated air pumps to pressurize the sprayer tanks can easily be modified to be an example of an Easy Sprayer. The quickest way to accomplish this is to simply bond the three main components, the base 5, the foot-operated air pump 4 and the sprayer tank 7 together as in FIG. 3. Bonding agents such as those used in the automotive industry, for example metal-to-metal bonders, plastic to metal bonders, plastic-to-plastic bonders, etc. can be used for the before said purpose. An air-inlet 2 located generally on the upper section of the tank of the sprayer apparatus connects the foot pumps' air hose 3 to said tank by way of a quick disconnect coupling. An automotive clamp-in valve stem can be used to quickly provide said air inlet 2 for the before said tank of the before said sprayer apparatus. Said air inlet providing a means of allowing an external air supply to be used to pressurize the tank of the before said sprayer apparatus. The external air supply provided by the before said foot pump. Some models of sprayers on the market today are equipped with pressure release valves that are part of removable caps, the caps can be unscrewed from the tanks the pressure release valves removed and replaced with automotive clamp-in valve stems. By providing an alternate air inlet 2 to the sprayer tank of a spraying apparatus and bonding a foot pump 4 and a sprayer tank 7 to a base 5 the utility design of the invention this composition of subject matter called the Easy Sprayer is effectively copied.

The descriptions given for the construction and operation of models of an Easy Sprayer Base Assembly and models of completed Easy Sprayer Assemblies should be considered as the exemplifications of the functional design presented in the invention and are not meant to be restricting/limiting to further designs of the disclosure.

The filler cap and a handle made as one solid piece 1 to take the place of designs of the caps that incorporate a built in hand-pump. An air inlet 2 to connect the foot pumps' airline 3 is located generally on the upper section of the sprayer tank 7. It is through this opening that the sprayer's tank is pressurized. The foot pump 4 used to supply the air to pressurize the sprayer tank, and the tank 7 used to hold a liquid under pressure in order to facilitate the application of said liquid onto a surface; are attached to the base 5 in a number of ways. Method 1 glue/bond FIG. 3 the foot pump and the tank to the base with bonders such as those used in the automotive industry. Method 2 Bolt FIG. 4 the foot actuated manual air pump the sprayer tank and the base to together. Method 3 snap, FIG. 5 the foot actuated manual air pump sprayer tank and the base to together. Method 4 slide lock FIG. 6 the foot pump and the sprayer tank to the base. Method 5 twist lock FIG. 7 the sprayer tank to attach it to the base. Different combinations of these assembly methods can be used FIG. 8 shows the foot pump and the sprayer tank in a combination slide and bolt design. FIG. 9 shows an example of a type of universal restraint 9; the restraint adjusts to hold sprayer tanks of various sizes. In this example a sprayer tank is placed between three strips of a sturdy material each strip designed with an adjustment at its' base, the tank is held in place with a band that presses the material against the tank as the band is tightened.

The design of an EASY SPRAYER ASSEMBLY (examples FIG. 10 through FIG. 14) and the design of an independent Easy Sprayer Base and foot-pump assembly (examples view FIG. 18A, FIG. 19A and further examples of the base assembly with tank 7 added FIG. 15, FIG. 16, FIG. 17, FIG. 18B and FIG. 19B to form a complete Easy Sprayer Assembly) can take many forms. Many different designs and types of foot-operated manual pumps 4 can be part of an Easy Sprayer Assembly. A foot-operated manual pump can be incorporated directly into as shown in (FIG. 10), onto as in (FIG. 11, FIGS. 13 and 14) under as in (FIG. 12), in front of and facing as in View FIG. 1, In front of facing and to one side of as in View FIG. 22, or in front and the foot pump turned to one side as in View FIG. 13 through FIG. 19B or View FIG. 26 The tank of a sprayer apparatus in an Easy Sprayer Assembly. FIG. 15 and FIG. 16 show illustrations of examples of different types of pumps. The Easy Sprayer Assembly can be dominated by the design of the sprayer tank as shown in FIG. 13 and FIG. 14 which show a design in which the base for the foot pump is a small off shoot of the sprayer tank. The base is a more prominent part of the Easy Sprayer Assembly in FIG. 10. FIG. 11, and FIG. 12. FIG. 15 through FIG. 19B illustrate the addition of handles extending upwards from the base of the Easy Sprayer Base Assembly. The use of such handles as part of an Easy Sprayer Base and foot pump assembly make it unnecessary to tightly secure the sprayer tanks that are installed on them, because the handles of the sprayer tanks are no longer used to carry the assembly. The base handles that extend up from an Easy Sprayer Base can be made adjustable in height and in position as shown in FIG. 17 adjustable in position as shown in FIG. 19A and in FIG. 19B.

The base 5 in the basic design of the Easy Sprayer can be designed as a lightweight dolly 10 on which a foot pump 4 and sprayer tank 7 are then attached (see FIGS. 20A and 20B); (FIG. 21A and FIG. 21B) and (FIG. 22)

FIG. 21A illustrates an Easy Sprayer Base Assembly the claimed improvement in the art of spraying equipment; an assembly made up of a supporting base 5 and a foot pump 4 the basic functional design elements of the disclosure incorporated directly in a dolly 10. Adding a solidly attached sprayer apparatus to the assembly illustrated in FIG. 21A creates a basic example of the Easy Sprayer Assembly's functional design concept, incorporated directly in a dolly 10, FIG. 21B.

A dolly 10 may incorporate a tray or basket 11 means of restraint The sides of said tray or basket restraint used as a means to secure components of or a complete version of the claimed invention. The said tray or basket means of restraint allows easy installment of a spraying apparatus onto a said dolly 10, enabling the said spraying apparatus to be more easily, transported. Said incorporated tray or basket 11 allows easy removal of said sprayer apparatus from said dolly 10 allowing the operator of the apparatus to access areas that are not as accessible with a dolly; a common occurrence (see FIG. 22). See also (FIGS. 23A and 23B) and (24A, 24B and 24C) that illustrate the use of a dolly 10 with a base designed as a tray 11. The trays in the two embodiments represented in (FIGS. 23A and 23B) and (FIGS. 24A 24B and 24C) are designed in the shape of the base of the hand carried Easy Sprayer assemblies said Easy Sprayer assemblies used in conjunction with or independently of the dollies 10 represented in the two embodiments shown.

View FIG. 22 illustrates a complete Easy Sprayer Assembly, an Easy Sprayer Base Assembly incorporated in the design of a dolly 10 designed for large heavy sprayer tanks 7. The said base assembly of foot pump 4 and base 5 with adjustable restraints 9 and a tray/basket 11 for securing a tank 7 of a sprayer assembly in close proximity to the before said foot pump 4 of the before said Easy Sprayer Base Assembly is incorporated in the design of a dolly 10 in view FIG. 22. Making said dolly a version of an Easy Sprayer Base Assembly. The before said tank 7 being also shown in View FIG. 22 makes the assembly a full version of the claimed invention an Easy Sprayer Assembly Once the said dolly 10 is stood upright, the claimed invention can be actuated. The embodiment shown in view FIG. 22 has all the essential components, and arrangement of said components that enable the description Easy Sprayer Assembly. A base support 5 bolted under the main framing 16 of the dolly 10 is made of a high strength plastic to resist corrosion. The before said dolly 10 made of ⅜ inch steel tubing the main frame member 16 of said dolly 10 formed from a single piece of ⅜″ steel tubing bent into the shape of a rectangle. The said tubing bent to form an upper rectangular member and a lower rectangular member. Said members are bent perpendicular to one another forming the shape of an L. Smaller frame member 17 are welded to said L-shaped main frame member 16, to reinforce said member 16 and aid in securing a tank 7 of a sprayer assembly upon the dolly 10 of view FIG. 22. The tank 7 of a spraying apparatus is supported by the base 5 and secured within the frame railing of the before said dolly 10. The said tank sets upon the base near the rear edge of said base, and within the frame rails of the dolly 10. The said frame railing along with adjustable restraints 9 and or basket/tray 11 secure the said tank 7 for transport by said dolly 10. The base 5 supports the assembly when the assembly is an upright position. Once in an upright position the base 5 provides operational support for the actuation of the manual foot pump 4 the said foot pump 4 solidly attached to the supporting base 5 provides compressed air when actuated. The air exits the foot pump 4 through its attached airline 3 enters the tank 7 of a spraying apparatus by way of a quick disconnect coupling attached to an air inlet 2 said air inlet located generally on the upper section of the tank 7. The said tank 7 secured upon the base 5 of the assembly within the frame of the dolly 10 by means of basket/tray 11 and or adjustable restraints 9 said restraints being removable straps or bands connected to front rails 17 of dolly 10. The dolly 10 is generally 3 feet in height when the assembly sets flat on its supporting base 5. The basic design structure of the dolly is that of a weight carrying dolly that one would generally see used to haul things such as parts supplies or equipment for a wide range of businesses, homes etc. Like most of the common designs of dollies the basic dolly designs that incorporate the claimed invention are conveyed by wheels attached to brackets, that extend perpendicularly back from the upper member of the L shaped main frame 16 of the dolly 10. The said wheels 19 bolted to the before said brackets 18 with the leading front edge of the wheels 19 positioned behind the main railing and more particularly behind the supporting base 5 of the dolly 10. The wheels 19 of the dolly 10 in view FIG. 6C are of six inches or seven inches in diameter. The brackets 18 extend from the rear of rails 16 at a height that allows attachment of wheels 19 to the said brackets 18 so that said wheels 19 are an eighth of an inch or higher off the ground when the assembly is in its upright position. Attached to the base 5 is a foot actuated manual pump 4 in front of and to one side of the tank 7 of a spraying apparatus. The said spraying apparatus generally composed of parts of common occurrence said parts generally being a tank 7 a pressure release valve 8, a sprayer hose and nozzle assembly 6, an air line 3, an air inlet. 2, and a filler cap The before said tank 7 is also supported by the base 5 and further secured by adjustable restraints of straps bands or chains 9 and or tray/basket 11. The before said wheels 19 are attached to the before said brackets 18 by axle bolts/I bolts 20. The basic design allows for good clearance over rough terrain or high grass. The brackets 18 extending from the rear of the L frame member 16 provide this high ground clearance. The further the brackets 18 that hold the wheels 19 extend from the supporting frame and base 5 and the larger the diameter of the wheels 19 the hire the clearance achieved. This embodiment holds securely a tank 7 of different liquid capacities, tanks that hold two, three, or four gallons. Each of said tanks manufactured with the same circumference but with different heights, to fit securely with little effort within a circular tray/basket 11 said tray/basket 11 located at the base 5 of the assembly and between the side railings of the dolly 10; and further secured with a sturdy belt, strap, chain, or band 9.

The design of an Easy Sprayer Assembly may vary greatly however the functional design description of that which is the invention remains constant. The functional description being a sprayer assembly that requires an operator's use of a foot actuated manual pump 4 to pressurize the tank 7 of a sprayer apparatus, the two said components connected close together on a common base/platform 5. The said base/platform providing support and stability to the assembly as the operator repeatedly pushes down on and releases the foot actuated manual pump 4 to pressurize the sprayer tank 7 of the assembly: see the many View FIG. 1 through FIG. 24C. FIG. 26 is another variant of design of an Easy Sprayer Assembly when the claimed invention is incorporated in the design of a dolly 10 making the dolly a version of an Easy Sprayer Similar to that of View FIG. 22. The dolly of view FIG. 26 has an L shaped main frame 16, reinforced with two smaller frame members 17, one on each side that extends up from the base of the L shaped main frame member 16 curving as they near the top to connect to the upper member of the L shaped frame 16, as does View FIG. 22. With wheels connected to the frame by brackets 18, made and positioned on the frame with the circumference of the wheels 19 in mind. As a safety, precaution the wheels 19 are of a diameter and position to be off the ground when the assembly is up right for the operation of the foot actuated manual pump 4. Note means of locking the wheels of the dolly can be devised when said dolly is stood upright negating the safety issue of the wheels remaining on the ground. The brackets 18 and wheels 19 are positioned generally on the main framing 16 so that the forward leading edge of the wheels 19 are rear of the base 5 support's rear edge. The before said wheels 19 are connected to the said brackets 18 with I bolts 20. The tank 7 is raised as in View FIG. 10 through FIG. 12 the tank 7 generally centered between the frame railings generally in a basket type restraint 11. The center of the tank is further generally above the rear edge of the supporting base 5. The said tank 7 held in a slightly tilted position the top bias forward toward the base support 5. The rear of the base support 5 positioned in front of the forward edge of the wheels 19 of the dolly 10. The use of I bolts 20 instead of an axle shaft, and further an elevated and set back basket type restraint 11 provides useful clearance should the assembly need to be pulled over rough terrain. Further clearance is secured by removing a small inner section 22 of the rear of the base support 5 generally rectangular, generally three to four inches forwards beginning from the rear edges. The elevated and set back basket 11 design in view FIG. 26 has the added effect of allowing for a shorter and less wide base support 5 than that of View FIG. 22. The foot-pump 4 in view FIG. 26 positioned on the base support perpendicular to the wheels 19 of the dolly 10. The said pump turned to one side in front of the tank 7 of the sprayer as apposed to the parallel position of the foot-pump 4 to the wheels 19 and foot-pump 4 facing and to the side of the tank 7 in View FIG. 22. The foot-pump 4 in view FIG. 26 is positioned in relation to the elevated sprayer tank 7 of the said view similarly to view FIGS. 13 through 18B in these views only a small amount of the area of the base support 5 extends beneath the foot actuated manual pump 4. An airline 3 extends from the foot actuated manual pump 4 to connect generally to the upper section of the sprayer tank 7. Note embodiments of the Easy Sprayer Assembly that are equipped with sprayer assemblies designed with complicated internal means of pressurization, may require means other than an air line 3 to provide air to the sprayer apparatus, for the said sprayer apparatus to function as the inventor intended. The external means of operating the internal pressurization system, said means generally being a hand operated lever would have to be replaced with a foot operated lever 4a turning a hand actuated pump into a foot actuated pump 4 (See view FIG. 10.) (See Yamamoto's U.S. Pat. No. 6,155,498).

The components of the Easy Sprayer Assembly that form the fundamentals of the utility can be included as the main components of conversion kits (Example FIG. 25). Such a kit will provide a base assembly capable of being equipped to sprayer tanks of various diameters within a given range. The must direct way to accomplish this is to incorporate a clamping mechanism 9 a simple restraint designed to allow the attachment of sprayer tanks of many different brands and models of sprayers onto the base of an assembly. 9 of view FIG. 9A shows a sheet metal assembly, one section bolted directly to the base, is one and one half feet tall, four inches wide, with a long clamp located near the top that fastens around the second section and a sprayer tank. The second section held in place by a strip of metal four and one half inches long one inch wide, slides on the base in order to adjust to sprayer tanks of different diameters. The said restraint is one and one half feet tall three inches wide, with a long clamp six inches above the base to fasten around the first section and a sprayer tank. The foot pump provided in such a kit can quickly be installed on the base by using methods described in FIG. 3 through FIG. 8

Models of an Easy Sprayer Base and foot pump assembly that incorporate dollies as shown in FIG. 22, or models designed with out dollies as shown in FIG. 9, or as with the base foot-pump and restraint of 9 are perfect for use in conversion kits or in full factory models of an easy sprayer. By using a simple restraint, 9 such as that in view FIG. 9, or that in view FIG. 25. Sprayer tanks of different brains and models can be attached to an Easy Sprayer Base and foot pump assembly, examples of a base 5 and foot pump 4 assembly FIG. 18A, and FIG. 19A, or to an Easy Sprayer Base 5 foot pump 4 and dolly 10 assembly FIG. 22. With the addition of other necessary parts from a conversion kit, these sprayers are converted into versions of an Easy Sprayer. FIG. 22 shows a basket type retainer as part of the platform that holds a sprayer tank. The sprayer tanks used on this platform have different liquid storage capacities, but with the same circumference so that any of several models of tanks can fit onto the dolly with little need of adjustments. This same basic design in an Easy Sprayer Base with foot pump and dolly assembly, can be used as a component of a conversion kit to secure the tanks of many different brands of sprayer assemblies.

Adapters designed to provide means of attachment of an airline of an-external source of air supply to the tanks of different models of sprayer assemblies currently on the market can be part of kits FIG. 25, containing the necessary parts to transform the sprayer assemblies of different manufacturers into versions of an Easy Sprayer. Adapter 12 is installed at the opening on the tanks of sprayer assemblies, said opening normally provided for the connection of the sprayer hose and nozzle assemblies of the various spraying apparatus. An air inlet 2 appears just above the sealing lip of the said adapter 12. Once adapter 12 is connected to the tank at the sprayer nozzle location, the original hose and nozzle assembly is then reconnected to the tank by way of the before said adapter 12. Means of extending the siphoning tubing of the said sprayer nozzle is provided in the before said Kit. Adapters designed for the openings of accessories such as pressure release valves are of a similarity in design as that of the adapters designed for the opening of the sprayer nozzle assembly said adapter providing means of attachment for the displaced accessory to said adapter once adapters is screwed into place. Filler tops with solid handle 1 and an air inlet 2 are designed as adapters, when used from an adapter kit replaces the tops with hand pump designs of different sprayer assemblies. A chemical resistant tubing extends from the air inlet down into the tank to provide the effect of agitating the liquid in the tank as the tank is being pressurized in a similar manner as would have been experienced if a hand actuated manual pump emerged in the said liquid of said tank were used. A section of sprayer hose 14 can be included in the kit with hardware; to be used to extend the length of the of the sprayer hose of the sprayer being converted. Different kits must be made brand name and model specific, to account for the different specifications of the openings for the accessories, sprayer hose connections and hand pump and top assemblies of different brands and models of garden sprayers

### PREFERRED EMBODIMENTS

By simply, providing various designs of the contrivance/device chiefly illustrated in view FIG. 2; that accommodate the various designs of the tanks of the many sprayer apparatus in the art, virtually any portable sprayer apparatus designed for outdoor use for spraying liquid insecticides, pesticides, herbicides or other liquids, can be incorporated in the design of an Easy Sprayer Assembly. There are two basic embodiments of the invention hand carried and transported by dolly. The aesthetic designs of the embodiments of the contrivance/device are wide-ranging, as demonstrated by the several drawings, view FIG. 10 through FIG. 24C.

One preferred embodiment of the invention features a sprayer apparatus carried by hand chiefly illustrated in view FIG. 1. Said spraying apparatus comprises a base 5 generally rectangular in shape said support made of treated quarter-inch plywood. Firmly attached to the said base is a foot actuated manual pump 4 of a type commonly found in auto parts stores, manually actuated foot pumps of other designs and types may be used including designs that pump liquid from a sprayer tank. The said foot pump is placed in close proximity to the tank 7 of a spraying apparatus, the said tank generally being of two or three gallon capacity is also firmly attached to the before said base 5. The before said tank and said base may be molded separately or together as a unit from a high-density chemical resistant polymerized material. Materials such as fiberglass, a thin sturdy metal or a high-density plastic may also be used to fabricate the base support, incorporating in the design of the base any variety of features that allow for the attachment of said foot pump and the tank of said sprayer assembly to said base. The said foot pump and the said tank, designed with features corresponding to those of the base as illustrated in view FIG. 3 through view FIG. 9. The airline 3 extends up from the foot pump 4 to connect generally to the upper section of the sprayer tank 7 by way of a quick disconnect coupling not shown at air inlet 2. Said air inlet 2 may be located on the main body of sprayer tank are incorporated in the filler cap of said tank. The filler cap with incorporated handle 1 molded as one solid piece or molded as two separate pieces then assembled to make one solid piece. The said to filler cap used to seal and carry the sprayer assembly may or may not also have an air inlet 2 incorporated in its design. The remaining components of common occurrence are a pressure release valve located generally on the upper section of the tank and a sprayer hose and nozzle assembly connected generally on the upper section of said tank.

One preferred embodiment of the present invention illustrated in view FIG. 22 is an Easy Sprayer Base Assembly incorporated in the design of a dolly. Said assembly of foot-pump 4 and base 5 with adjustable restraints 9 and a tray/basket 11 for securing a tank 7 of a sprayer assembly in close proximity to the before said foot pump of the before said Easy Sprayer Base Assembly is incorporated in the design of a dolly 10. Making said dolly a version of an Easy Sprayer Base Assembly. The embodiment shown in view FIG. 22 has all the essential components, and arrangement of said components that enable the description Easy Sprayer Assembly. A base support 5 bolted under the frame of the dolly 10 is made of a high strength plastic to resist corrosion. The before said frame made of ⅜ inch steel tubing the main frame member 16 of said frame formed from a single piece of ⅜″ steel tubing bent into the shape of a rectangle. The said tubing is thin bend again to form an upper rectangular member and a lower rectangular member. Said members are bent perpendicular to one another forming the shape of an L. Smaller frame members 17 are welded to said L-shaped main frame member 16 to reinforce said member 16 and aid in securing tanks of sprayer assemblies upon the dolly 10 formed from said framing. The tank 7 of a spraying apparatus is supported by the base 5 and secured within the frame railing of the before said dolly 10 The said tank 7 sets upon the base 5 near the rear edge of said base, and within the frame rails of the dolly 10. The said frame railings 16 and 17 along with adjustable restraints 9 and or basket/tray 11 secure the said tank 7 for transport by said dolly 10. The base 5 supports the assembly when the assembly is an upright position. Once in an upright position the base 5 provides operational support for the actuation of manual foot pump 4 the said foot pump solidly attached to the supporting base provides compressed air when actuated. The air exits the foot pump through its attached airline 3 enters the tank 7 of a spraying apparatus by way of a quick disconnect coupling attached to inlet 2 said air inlet located generally on the upper section of the tank 7. The said tank 7 secured upon the base 5 of the assembly within the frame 16 and 17 of the dolly by means of basket/tray 11 and or adjustable 9 said restraints being removable straps or bands connected to front rails of dolly. The dolly is generally three feet in height when the assembly is flat on its supporting base. The basic design structure of the dolly used in the preferred embodiment is that of a weight carrying dolly that one would generally see used to haul things such as parts supplies or equipment for a wide range of businesses, homes etc. Like these designs the dolly in the preferred embodiment are conveyed by wheels attached to said dolly by way of brackets 18, that extend perpendicularly back from the main support rails 16 of the dolly 10. The wheels 19 in the preferred embodiment are bolted to the before said brackets. The leading front edges of the wheels 19 are positioned behind the main railing 16 and more particularly behind the supporting base 5 of the dolly 10. The wheels 19 of the dolly in this embodiment are of six inches or seven inches in diameter. The brackets 18 extend from the rear of rails at a height that allows attachment of wheels 19 to the said brackets so that said wheels are an eighth of an inch or higher off the ground when the assembly is in its upright position. Attached to the base 5 is a foot actuated manual pump 4 in front of and to one side of the tank 7 of a spraying apparatus. The said spraying apparatus composed of parts (pressure release valve 8, tank 7, sprayer hose and nozzle assembly 6, air line 3, air inlet 2, filler cap 1). The before said tank is also supported by the base and further secured by adjustable restraints or straps bands or chains 9 and or tray/basket 11. The before said wheels 19 are attached to the before said brackets 18 by axle bolts/I bolts 22. The basic design allows for good clearance over rough terrain or high grass. The brackets 18 extending from the rear of frame rails 16 provide this high ground clearance. The further the brackets that hold the wheels extend from the supporting frame 16 and base 5 and the larger the diameter of the wheels 19 the hire the clearance achieved. This embodiment holds securely tanks of different liquid capacities, tanks that hold two, three or four gallons. Each of said tanks manufactured with the same circumference but with different heights so that said tanks would fit securely with little effort within a circular tray/basket 11. Said tray/basket located at the base 5 of the assembly and between the side railing 16 and 17 of the dolly 10; and further secured with a sturdy belt, strap, chain, or band 9.

There are many possible embodiments of the invention. No embodiment shown should be limiting to the designs of future embodiments. Note the illustration in FIG. 26 a design based upon the embodiment illustrated in FIG. 22. It incorporates design features from several of the views of the drawings, making an assembly similar to FIG. 22, but more compact with a slight improvement in portability. In FIG. 26, the tank 7 of a sprayer apparatus is elevated to a height above the axles of the wheels of a dolly 10. The said tank 7 is located within the framing 16 and 17 of the dolly 10. Supported by a brace 21 that extends between the upper L frame rails 16 above the rear edge of the base support 5 so that the middle of the tank 7 sets midway the rear edge of the supporting base 5 of the assembly. The said tank 7 secured in a basket type restraint 11 A section 22 of the base 5 generally rectangular is removed from the rear of the base 5 said removal beginning generally three inches from the outer left and three inches from the outer right side of the base, and extending three or more inches in from the rear of the said base 5. The foot pump 4 of said base 5 is turned so that the tank 7 of a sprayer apparatus faces its' side. Restraint means for the tanks of various sprayer apparatus, can be designed for a wide range of tank diameters and are shapes. Larger or heavier tubing used in a dolly design accommodates larger tank capacities. High-density plastics may be used in molds to form the before said dollies. Dollies constructed from quarter inch plywood then treated with weatherproofing materials may be used.

View FIG. 25 illustrates elements of a kit designed to convert sprayer assemblies of various manufacturers into versions of an Easy Sprayer Assembly. The components used in the kits or of common occurrence. A kit may contain some or all of the components suggested in view FIG. 25. A full conversion kit contains some version of an Easy Sprayer Base Assembly design, specifically a base 5 a foot pump 4 and means of restraint for the tank of a sprayer assembly. In addition to the said base assembly contained in the kit would be sprayer nozzle holes and hardware 14 of view FIG. 25 to splice said holes into the nozzle holes of the spraying apparatus being converted to extend the length of the sprayer nozzle holes of the sprayer assembly being converted. Also contained in the kit would be one of several means of providing an air inlet to connect the foot pump of the base assembly to the tank of the spraying apparatus. One means of providing an alternative air inlet for the tanks of spraying apparatus of different manufactures is to replace the original filler cap with built in hand pump with an adapter a filler cap with solid handle 1 a long with a built in air Inlet 2. Adapter 12 (see view FIG. 25) represents another means of providing an air Inlet for the foot pump of the Easy Sprayer Base Assembly. To use adapter 12 shown in view FIG. 25 remove the sprayer nozzle assembly 6 from the tank of the sprayer assembly, the adapter 12 which has a built in air inlet 2 is then installed onto the location the sprayer nozzle assembly was removed from. The sprayer nozzle and holes assembly 6 is then reinstalled onto the sprayer assembly by way of the said adapter 12. To use adapter 13 with built in air inlet 2 shown in view FIG. 25 remove the pressure release valve 8 from its location install adapter 13 in the before said location then reinstall pressure release valve 8 to adapter 13. The adapters used in the before said conversion kits generally would be made brand name specific because there are many manufactures of the art and specifications for the different openings of their apparatus differ greatly.

What I claim is:

1. an operating format that is an improvement in the art of pressurized sprayer assemblies said format comprising
(a) a foot operated manually actuated pump of any kind; attached in close proximity
(b) to a tank of a sprayer apparatus said sprayer apparatus generally of a kind used to spray liquid herbicides, insecticides fertilizers; and other liquids the two said components of foot operated manually actuated pump and the tank of a sprayer apparatus commonly connected
(c) to a third component a base/support and operating platform, the said base/support and operating platform ranging in design any where from a simple flat board to complicated designs of dollies, the three components together form an operational format unique in the art of pressurized sprayer assemblies all embodiments of the said operational format providing:
(a+) a platform to be placed stationary and flat on the ground for the operation of a pressurization means said means being any manually operated pump that requires the use of the human foot to operate said means to cause the pressurization of a tank attached to the said platform the said pressurization means in close proximity to the before said tank,
(b+) a foot actuated manual pump said pump in close proximity to the tank of a sprayer apparatus the said foot actuated manual pump and the said tank of the sprayer apparatus attached to a common platform the base of said platform when placed flat on the ground provides support and stability for the operation of the foot actuated manual pump the said foot actuated manual pump operated by a person standing erect said person repeatedly pushing down on then off of the operating means of the said foot operated manual pump, to pressurize the tank of the sprayer apparatus,
(c+) a tank in close communication to a foot operated manual pump the said tank solidly or remove ably connected to a platform common to the before said tank and foot pump, the said platform having a flat base a section of said base extending beneath the foot actuated manual pump providing stability as the foot actuated manual pump is actuated to cause the pressurization of the before said tank.

2. a functional design: of platform of claim 1 with the descriptive name Easy Sprayer Base Assembly; an assembly comprising:
(a) a first component a supporting base the said base being a thin flat sturdy surface a said supporting base being incorporated in any design of base assembly of claim 1 wherein a manually operated foot pump used in a said base assembly is of any type, and or design of foot actuated manual pump, a said pump designed generally as an exterior source of air supply, for a tank of a sprayer apparatus, a said tank met to be installed onto a before said base assembly, a said foot actuated pump attached to a said base/supporting platform, said base/supporting platform being of any design, a said design ranging from a simple flat surface onto which both a foot actuated pump and a tank of a sprayer apparatus are connected, to designs that incorporate the use of dollies, designs carried by handles, to designs pulled or pushed along supported by the wheels of a said dolly, to designs that use combinations of the two molds of transport, simple designs of a said Easy Sprayer Base Assembly in which the three basic components of a completed Easy Sprayer Assembly are separate parts working together, to designs in which the said three main components are merged together as a unit, from designs in which a foot actuated pump is connected to a flat supporting base said foot actuated pump independent of a sprayer tank that it is to pressurize, to designs in which a foot actuated pump is connected directly to the tank of a sprayer apparatus, from designs in which a foot actuated pump is connected to the exterior of a sprayer tank, to designs that in a change from providing the general external source of air supply, provides a foot actuated pump built directly into a tank of a sprayer apparatus, in some of said designs the supporting platform is the tank of a sprayer apparatus, a said tank being the dominate feature of some of said assemblies all the remaining components incorporated directly into or onto the body of the said tank, any of the said base assemblies when placed on the ground supports the operation of the second component of an Easy Sprayer Base Assembly,
(b) a foot actuated manual pump; a said foot actuated manual pump generally solidly attached to the before said base; the said foot actuated manual pump providing a means of pressurization for a tank of a spraying apparatus, the said manually operated foot pumps connected to the said base assembly being of any type, and or design of foot actuated manual pump; said pumps generally provided, as external sources of air supply, for the tank of a sprayer apparatus, said pumps generally connected to said tank by way of an air-line, said air-line generally connected to the upper section of the tank of a sprayer apparatus, the before said foot pumps connected in front of, to one side of, under or directly onto the body of the tank of a sprayer apparatus; some pumps internal parts of a sprayer apparatus the direct use of said pumps necessary for the apparatus to function as the inventor/s intend.

3. A functional design of platform of claim 2 with the descriptive name Easy Sprayer Base Assembly, a tank of a sprayer apparatus said tank attached to or being a variant of a said platform a said tank being of any manually pressurized sprayer apparatus or of any sprayer apparatus normally pressurized by a means other than the common hand pump the said sprayer apparatuses generally used for the dispensing of insecticides herbicides, fertilizers, industrial compounds or other are modified/designed to be pressurized by a manual means said means operated by the use of the human foot, a variant of a before said base assembly designed to be used in conjunction with any of said sprayer apparatuses, a tank of any of said sprayer apparatuses secured to a before said variant of the platform descriptively called an Easy Sprayer Base Assembly, creates a sprayer assembly with the descriptive name Easy Sprayer Assembly said Easy Sprayer Assembly comprising:
(a) first component an Easy Sprayer Base Assembly of claim 2; said Easy Sprayer Base Assembly supporting
(b) a second component a sprayer apparatus; the tank of a said sprayer apparatus connected to the before said Easy Sprayer Base Assembly in close proximity to the foot pump of the said Easy Sprayers Base Assembly; the resulting Easy Sprayer Assembly comprising:
(a+) a first component a foot actuated manual pump attached to;
(b+) a second component a platform/base; said platform/base supports the operation of the before said foot actuated manual pump; said foot pump provides means of pressurizing the tank of
(c+) a third component a sprayer apparatus the before said tank provided means of attachment to the before said base/platform in close proximity to the said foot actuated manual pump.

4. A hand carried portable assembly of claim 3 descriptively called an Easy Sprayer Assembly, an assembly for spraying any of liquids, herbicides, insecticides, fertilizers, or other liquids, said assembly comprising:
(a) a platform/base comprising: a thin flat study surface, said surface being a base/support of the said assembly said base made of a high density plastic, a strong thin metal plate; treated quarter-inch plywood or fiberglass or molded along with a tank as a unit from a chemical resistant polymerized material; is generally rectangular in shape sits flat on the ground during the actuation of
(b) a foot actuated manual pump connected to the said base, the said pump used to pressurize
(c) a tank of a sprayer apparatus used in the assembly; the before said base, also providing means of attachment of the tank of the spraying apparatus, to said base, the said tank placed in close proximity to the before said foot actuated manual pump the said foot pump a means of pressurizing the tank of the said sprayer apparatus said sprayer apparatus sealed doing the pressurization of the said tank of the said sprayer apparatus; by a filler top designed with a solidly incorporated handle; the said handle is used to pick up and carry the assembly after said tank is pressurized generally by way of an air inlet said air inlet located generally on the upper section of the tank or in the filler cap of said tank, of the sprayer apparatus allowing the attachment of an air line from the before said foot pump attached to the tank of said spraying apparatus through the air inlet by way of a quick disconnect coupling provides means of allowing pressurized air into the tank of the spraying apparatus the said tank of said spraying apparatus protected from over pressurization by a pressure release valve a hose and nozzle assembly of said spraying apparatus provides means to apply the contents of the tank to a surface.

5. A hand carried portable sprayer assembly of claim 4: its three main components manufactured with corresponding features if common occurrence providing means of easy assembly of the said components said means being glue or bond components together, bolt components together, snap components together, slide lock components together, twist lock components together; or use combinations of means described to restrain components.

6. A hand carried portable assembly of claim 4 wherein: the tank dominates the design of the Easy Sprayer Assembly and the assembly is carried not by the handle of the filler top but by a handle incorporated in the design of the tank of the sprayer apparatus, the said tank serving as the supporting platform of an assembly.

7. A sprayer assembly of claim 4 wherein the tank of the spraying apparatus is secured on the base with restraints such as chains belts or straps or a basket/tray the foot actuated pump generally in front of the tank and turned to one side and the assembly carried by a handle extended up from the base.

8. An Easy Sprayer Base Assembly of claim 3 wherein said assembly is incorporated in the design of a dolly said dolly comprising
(a) a frame of common occurrence in basic attached to the surface of
(b) a base support said base also supporting
(c) an attached manually actuated foot pump, said foot pump providing means of pressurizing the tank of a sprayer apparatus; said tank secured onto the before said dolly by
(b) an adjustable restraint of a belt, chain or band; with additional means of restraint for the tank of a spraying apparatus in the form of
(e) a tray or basket design on the before said base or within side rails of said dolly; said means of restraint designed to allow easy installation of the said tank of said sprayer apparatus onto said dolly and easy removal of said tank from said dolly.

9. A sprayer assembly of claim 8 for spraying any of liquids, herbicides pesticides, fertilizers, industrial compounds or other liquids, said sprayer assembly comprising
(a) a first component a sprayer apparatus for distribution of liquid chemicals said sprayer assembly secured to;
(b) a second component a dolly said dolly designed as an Easy Sprayer base assembly; said Easy Sprayer Base Assembly comprising
(a+) a frame made of ⅜ inch steel tubing the said tubing forming a basic L-shape frame; said frame bolted to
(b+) a thin flat sturdy supporting base forming an operating platform for the operation of
(c+) a foot actuated manual pump said foot-pump attached to the said base and facing forward and to one side of said frame that supports
(d+) the tank of the before said spraying apparatus with frame railing equipped with adjustable means of restraint to secure the tank of the said spraying apparatus, said means of restraint being belts chains, or bands said restraints along with additional means of restraint, said means being a basket/tray attached to the before said base; to provide convenient means of installing or quickly removing the tank of the before said spraying apparatus the said spraying apparatus when attached to the said dolly is secured in close proximity to the before said foot actuated manual pump; the said pump is connected to the tank of the said spraying apparatus by way of the airline of the said foot pump connected by a quick connect coupling to an air inlet located generally on the upper section of the before mentioned tank said tank when sealed by a filler cap is pressurized while the assembly sits upright the base of said assembly flat on the ground allowing for the operation of the before said foot pump pressurizing the before said tank, said tank containing liquid in communication with tubing from a sprayer nozzle assembly attached to the tank providing means of applying said liquid contained in the before said tank to plants; as the assembly is pulled along on wheels that are connected to the frame of the assembly behind the base support by brackets at least half the diameter of the wheels in length; the longer the brackets the higher the clearance of the base of the assembly from the ground when the assembly is titled on to the two supporting wheels for transport combining long brackets with wheels of wider diameters raising the height of the brackets in relationship to the frame as the diameters of the wheels increase results in even higher clearance; said wheels that are bolted to brackets by way of axle bolts/I bolts said brackets hold wheels just off the ground when the assembly is upright and foot pump is being actuated.

10. A sprayer assembly of claim 9 in wherein
(a) a sprayer tank is elevated a common occurrence above the base of the assembly generally in a central position within the main L shaped framing,
(b) said tank secured by a basket type restraint a common occurrence said basket connected to the framing titled slightly forwards so that the weight of the tank is biased towards the base support of the dolly,
(c) the before said tank generally supported by a brace that extends between the upper main frame railings generally above the rear edge of the supporting base at a height above the axles of the wheels
(d) the rear edge of the said supporting base located generally in front of the leaning edge of the before said wheels,
(e) a generally rectangular section of the before said supporting base extending forwards from the inner rear edges of the supporting base is removed adding clearance for pulling through high grass or rough terrain
(f) the remaining forward surface of the said supporting base provides just enough surface to connect a foot operated manual pump to the before said base
(g) said pump connected to the base in front of the before said sprayer tank and in a perpendicular position to the wheels of the assembly.

11. A sprayer assembly of claim 3 wherein any manually pressurized sprayer apparatus for the dispensing of insecticides herbicides, fertilizers, industrial compounds or other liquids may be modified/designed or a base assembly designed/modified to enable use of a said sprayer apparatus in a sprayer assembly of claim 3.

12. A sprayer assembly of claim 3 wherein in an Easy Sprayer Base Assembly is the major part of a kit; or is used in conjunction with a kit containing components used to convert sprayer apparatus of other manufacturers for use in an Easy Sprayer format.

13. A sprayer assembly of claim 3 wherein an adapter from a conversion kit is installed onto a tank of a sprayer apparatus to facilitate the use of said sprayer apparatus in an Easy Sprayer format said adapters providing means of attaching an airline from an external source of air pressure to pressurize the tank of the said sprayer apparatus.

14. A sprayer assembly of claim 3 wherein a sprayer apparatus of a design that incorporates a hand pump built into the filler cap is converted for use in an easy sprayer format by equipped with an adapter from a conversion kit,
(a) one said adapter being: a filler cap with out a built in hand pump but instead equipped with an air inlet located generally near the center of the cap;
(b) one said adapter in installed at the location of the pressure release valves on a spraying apparatus
(c) one said adapter is placed at the hose and nozzle location on a sprayer apparatus the before said pressure release valves and sprayer hose and nozzle assembly's are then reinstalled onto the sprayer assembly by way of the said adapters;
(d) said adapter being made brand name and model specific in accordance with the many differing specifications of the many different models of sprayer apparatus made by many different manufacturers.

15. A sprayer assembly of claim 3 wherein the tank of sprayer apparatus that are normally pressurized by means other than the common hand pump are converted for use with an Easy Sprayer Base Assembly; by eliminating the normal means of pressurization for the said tanks said means commonly being electric gas or diesel powered air compressors and providing means of attaching an airline from a foot actuated manual pump of the said Easy Sprayer Base Assembly to the before said tanks said being in the form of adapters designed to be installed generally at the same air inlet locations providing for the before said electric gas or diesel powered compressors.

16. A sprayer assembly of claim 3 wherein a sprayer apparatus used in conjunction with an Easy Sprayer Base is modified for use in an Easy Sprayer Assembly by modifying the design of the hand pump or lever of the said apparatus so that said pump or lever is operated by use of the operators foot.
